(19) United States
(12) Patent Application Publication
(10) Pub. No.: US 2025/0224622 A1
(43) Pub. Date: Jul. 10, 2025

(54) 2D/MULTIVIEW SWITCHABLE LENTICULAR DISPLAY, SYSTEM, AND METHOD

(71) Applicant: LEIA Inc., Menlo Park, CA (US)

(72) Inventor: Ming Ma, Menlo Park, CA (US)

(21) Appl. No.: 18/843,820

(22) PCT Filed: Jul. 30, 2022
(86) PCT No.: PCT/US2022/038972

§ 371 Date: Sep. 4, 2024

Related U.S. Application Data
(60) Provisional application No. 63/317,392, filed on Mar. 7, 2022.

(51) Int. Cl. G02B 30/28

(52) U.S. Cl. CPC G02B 30/28

(57) ABSTRACT

A display panel of a 2D/multiview switchable lenticular display may provide pixels of a composite image that includes a multiview image and a 2D image. A switchable lenticular lens array of the 2D/multiview switchable lenticular display may form the composite image from the pixels. Each switchable lenticular lens of the switchable lenticular lens array may be switchable between an ON state and an OFF state. The composite image may be provided either by using temporal mixing or by using zonal mixing. The temporal mixing may include time-multiplexing ON and OFF states of the switchable lenticular lenses of the switchable lenticular lens array. The zonal mixing may include switching different subsets of the switchable lenticular lenses corresponding to different zones of the composite image to the ON state to provide the multiview image or to the OFF state to provide the 2D image.

### CROSS-REFERENCE TO RELATED APPLICATIONS

This application claims the benefit of U.S. Provisional Application No. 63/317,392, filed on Mar. 7, 2022, the entirety of which is hereby incorporated by reference.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Examples of active displays include CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates a perspective view of a multiview display in an example, according to an embodiment consistent with the principles described herein.

FIG. 2 illustrates a graphical representation of angular components of a light beam having a particular principal angular direction corresponding to a view direction of a multiview display in an example, according to an embodiment consistent with the principles described herein.

FIG. 3 illustrates a side view of a 2D/multiview switchable lenticular display in an example, in accordance with some embodiments of the principles described herein.

FIG. 4 illustrates a block diagram of a 2D/multiview switchable lenticular system in an example, according to an embodiment of the principles described herein.

FIG. 5 illustrates a plan view of a composite image in an example, according to an embodiment of the principles described herein.

FIG. 6 illustrates a plan view of a composite image in another example, according to an embodiment of the principles described herein.

FIG. 7 illustrates an example of a method of operating a 2D/multiview switchable lenticular display, in accordance with some embodiments of the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a two-dimensional (2D)/three dimensional (3D) switchable lenticular display with application to displaying 2D images, multiview or 3D images, and mixed-content 2D/multiview hybrid images. In particular, according to the principles described herein a lenticular display may employ a switchable medium surrounding the lenses in a lenticular array of a lenticular display. The switchable medium (e.g., a birefringent liquid crystal medium) is used to effectively switch on and off various lenses of a lenticular array of the lenticular display. By switching on and off the various lenses, images having only 2D content, only multiview content or a combination or 2D/multiview mixed-content may be provided. According to various embodiments, a 2D/multiview switchable lenticular display comprises a backlight, a light valve array (e.g., a liquid crystal panel) and a switchable lenticular array. The 2D/multiview switchable display may be operated in various modes including a 2D mode configured to provide a 2D image, a multiview mode configured to provide a multiview image, and a 2D/multiview hybrid mode configured to provide a 2D/3D hybrid image. In addition, the 2D/multiview mode may include one or both of zonal mixing and temporal mixing to provide the 2D/multiview hybrid image, according to various embodiments.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A conventional liquid crystal display (LCD) found in many smart phones and computer monitors are examples of 2D displays. In contrast herein, a ‘multiview display’ or 3D display is defined as an electronic display or display system configured to provide different views of a multiview image in or from different view directions. In particular, the different views may represent different perspective views of a scene or object of the multiview image. Uses of unilateral backlighting and unilateral multiview displays described herein include, but are not limited to, mobile telephones (e.g., smart phones), watches, tablet computes, mobile computers (e.g., laptop computers), personal computers and computer monitors, automobile display consoles, cameras displays, and various other mobile as well as substantially non-mobile display applications and devices.

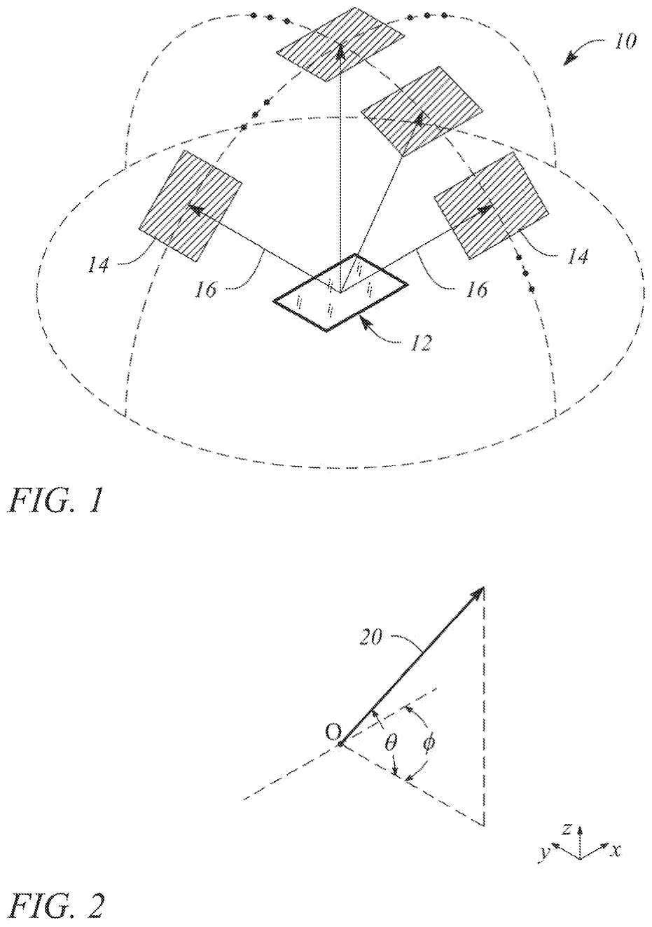

FIG. 1 illustrates a perspective view of a multiview display 10 in an example, according to an embodiment consistent with the principles described herein. As illustrated in FIG. 1, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions. The different views 14 are illustrated as shaded polygonal boxes at the termination of the arrows (i.e., depicting the view directions 16). Only four views 14 and four view directions 16 are illustrated, all by way of example and not limitation. Note that while the different views 14 are illustrated in FIG. 1 as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction given by angular components {θ,ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane). FIG. 2 illustrates a graphical representation of the angular components {θ,ϕ} of a light beam 20 having a particular principal angular direction corresponding to a view direction (e.g., view direction 16 in FIG. 1) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 2 also illustrates the light beam (or view direction) point of origin O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of sub-pixels representing ‘view’ pixels in each of a similar plurality of different views of a multiview display. In particular, a multiview pixel may have an individual sub-pixel corresponding to or representing a view pixel in each of the different views of the multiview image. Moreover, the sub-pixels of the multiview pixel are so-called ‘directional pixels’ in that each of the sub-pixels is associated with a predetermined view direction of a corresponding one of the different views, by definition herein. Further, according to various examples and embodiments, the different view pixels represented by the sub-pixels of a multiview pixel may have equivalent or at least substantially similar locations or coordinates in each of the different views. For example, a first multiview pixel may have individual sub-pixels corresponding to view pixels located at {x₁,y₁} in each of the different views of a multiview image, while a second multiview pixel may have individual sub-pixels corresponding to view pixels located at {x₂,y₂} in each of the different views, and so on.

Herein, a ‘light guide’ is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

Herein a ‘collimator’ is defined as substantially any optical device or apparatus that is configured to collimate light. For example, a collimator may include, but is not limited to, a collimating mirror or reflector, a collimating lens, a diffraction grating, and various combinations thereof. In some embodiments, the collimator comprising a collimating reflector may have a reflecting surface characterized by a parabolic curve or shape. In another example, the collimating reflector may comprise a shaped parabolic reflector. By ‘shaped parabolic’ it is meant that a curved reflecting surface of the shaped parabolic reflector deviates from a ‘true’ parabolic curve in a manner determined to achieve a predetermined reflection characteristic (e.g., a degree of collimation). Similarly, a collimating lens may comprise a spherically shaped surface (e.g., a biconvex spherical lens).

In some embodiments, the collimator may be a continuous reflector or a continuous lens (i.e., a reflector or lens having a substantially smooth, continuous surface). In other embodiments, the collimating reflector or the collimating lens may comprise a substantially discontinuous surface such as, but not limited to, a Fresnel reflector or a Fresnel lens that provides light collimation. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread be an angle determined by at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

Herein, a ‘multiview image’ is defined as a plurality of images (i.e., greater than three images) wherein each image of the plurality represents a different view corresponding to a different view direction of the multiview image. As such, the multiview image is a collection of images (e.g., two-dimensional images) which, when display on a multiview display, may facilitate a perception of depth and thus appear to be an image of a 3D scene to a viewer, for example. A multiview image that provides pairs of views that represent different but related perspectives of a 3D scene consistent with viewing by a viewer is defined as a 3D image.

By definition, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >±20°). In other embodiments, the broad-angle emitted light cone angle may be greater than about thirty degrees (e.g., >±30°), or greater than about forty degrees (e.g., >±40°), or greater than fifty degrees (e.g., >±50°). For example, the cone angle of the broad-angle emitted light may be about sixty degrees (e.g., >±60°).

In some embodiments, the broad-angle emitted light cone angle may defined to be about the same as a viewing angle of an LCD computer monitor, an LCD tablet, an LCD television, or a similar digital display device meant for broad-angle viewing (e.g., about ±40-65°). In other embodiments, broad-angle emitted light may also be characterized or described as diffuse light, substantially diffuse light, non-directional light (i.e., lacking any specific or defined directionality), or as light having a single or substantially uniform direction.

Embodiments consistent with the principles described herein may be implemented using a variety of devices and circuits including, but not limited to, one or more of integrated circuits (ICs), very large scale integrated (VLSI) circuits, application specific integrated circuits (ASIC), field programmable gate arrays (FPGAs), digital signal processors (DSPs), graphical processor unit (GPU), and the like, firmware, software (such as a program module or a set of instructions), and a combination of two or more of the above. For example, an embodiment or elements thereof may be implemented as circuit elements within an ASIC or a VLSI circuit. Implementations that employ an ASIC or a VLSI circuit are examples of hardware-based circuit implementations.

In another example, an embodiment may be implemented as software using a computer programming language (e.g., C/C++) that is executed in an operating environment or a software-based modeling environment (e.g., MATLAB®, MathWorks, Inc., Natick, MA) that is further executed by a computer (e.g., stored in memory and executed by a processor or a graphics processor of a general-purpose computer). Note that one or more computer programs or software may constitute a computer-program mechanism, and the programming language may be compiled or interpreted, e.g., configurable or configured (which may be used interchangeably in this discussion), to be executed by a processor or a graphics processor of a computer.

In yet another example, a block, a module or an element of an apparatus, device or system (e.g., image processor, camera, etc.) described herein may be implemented using actual or physical circuitry (e.g., as an IC or an ASIC), while another block, module or element may be implemented in software or firmware. In particular, according to the definitions herein, some embodiments may be implemented using a substantially hardware-based circuit approach or device (e.g., ICs, VLSI, ASIC, FPGA, DSP, firmware, etc.), while other embodiments may also be implemented as software or firmware using a computer processor or a graphics processor to execute the software, or as a combination of software or firmware and hardware-based circuitry, for example.

Further, as used herein, the article ‘a’ is intended to have its ordinary meaning in the patent arts, namely ‘one or more’. For example, ‘a lens’ means one or more lenses and as such, ‘the lens’ means ‘the lens or lenses’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

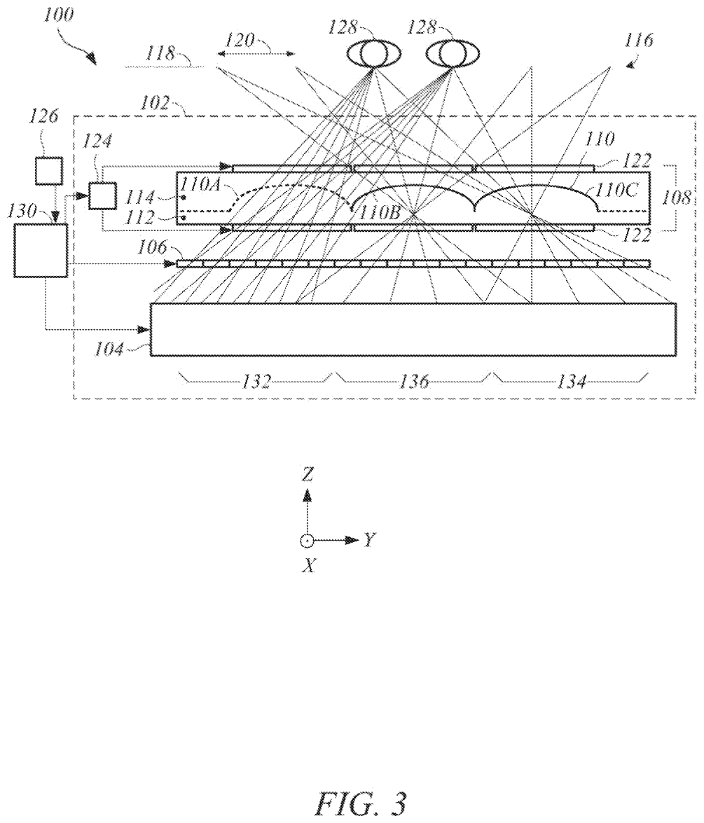

FIG. 3 illustrates a side view of a 2D/multiview switchable lenticular display 100 in an example, in accordance with some embodiments of the principles described herein. The 2D/multiview switchable lenticular display 100 comprises a display panel 102. In some embodiments, the display panel 102 may include a backlight 104 configured to emit light and an array of light valves 106 configured to modulate the light emitted by the backlight 104 to provide the pixels of an image, e.g., a of a composite image, described below. In other embodiments, other suitable configurations may also be used as the display panel 102, e.g., direct illumination displays such as, but not limited to, an organic liquid crystal diode (OLED) display.

In embodiments that employ a backlight, the backlight 104 may be configured to emit light, such as white light, into a range of propagation angles. In some embodiments, the range of propagation angles may include a continuous range of propagation angles extending across a range of angular spanning an angular viewing range of the display panel 102. The backlight 104 may include a light source, such as one or more light-emitting diodes, which may produce white light or light having a specified spectral profile, according to various embodiments. In some embodiments, the backlight 104 may include a light guide, which may be configured to propagate the light away from the light source. The light guide may direct light out of the light guide over a specified surface area of an emission surface of the light guide.

As illustrated in FIG. 3, the 2D/multiview lenticular display 100 further comprises an array of light valves 106. The array of light valves 106 is configured to modulate light from the backlight 104 to provide an image. In various embodiments, the array of light valves 106 may comprise, but is not limited to, liquid crystal light valves, electrophoretic light valves, light valves based on electrowetting, or other suitable mechanisms for modulating light. In some embodiments, the array of light valves 106 may comprise independently controllable light valves that are arranged on a substrate.

According to various embodiments, the display panel 102 may be configured to provide pixels of a composite image. The composite image may include both multiview image content and two-dimensional (2D) image content, in various embodiments. Combining multiview image content and 2D image content on the same display panel 102 may allow the 2D image content to be presented with a higher resolution than the multiview image content. For example, for an embodiment of the display panel 102 that produces four views of the multiview image content, the resolution of the multiview image content may be a factor of four less than the resolution of the 2D image content. As a specific example, the composite image may include an image of a person and a caption that includes text. In this example, the multiview image content may include the image of the person, such that as a viewer moves in a field of view of the display panel 102, the viewer may observe various different views of the person. In this example, the 2D image content may include the caption with text, which may remain invariant (e.g., with only a single view) as the viewer moves in the field of view of the display panel 102. In the example presented above, the display panel 102 may present the caption with a higher resolution than the image of the person, which may improve readability of the caption text.

The 2D/multiview switchable lenticular display 100 illustrated in FIG. 3 further comprises switchable lenticular lens array 108. The switchable lenticular lens array 108 may be used to form the composite image from the pixels, according to various embodiments. As illustrated, the switchable lenticular lens array 108 may comprise switchable lenticular lenses 110A, 110B, 110C, referred to collectively herein as switchable lenticular lenses 110. The switchable lenticular lenses 110 are switchable between an ON state and an OFF state. In the ON state, the switchable lenticular lenses 110 are configured to provide the multiview image content from corresponding pixels of the composite image. In the OFF state, the switchable lenticular lenses 110 are configured to provide the 2D image content from corresponding pixels of the composite image. For example, in the OFF state, a switchable lenticular lens 110 may effectively become a transparent optical element that lacks or substantially lacks optical power. That is, the switchable lenticular lens 110 in the OFF state pass light without or with only minimal degree of optical effect. In a region or regions of the 2D/multiview switchable lenticular display 100 configured to display 2D image content, the switchable lenticular lenses 110 may be set in the OFF state and therefore may not affect propagation directions of light rays exiting the display panel 102. As such, the pixels of the display panel 102 in these regions may be viewable from a continuous range of view directions, i.e., in or as a 2D image within the region.

Alternatively, when the switchable lenses 110 are set to the ON state, the switchable lenticular lenses 110 have an optical power and are configured to affect the propagation direction of various light rays from the display panel 102 that pass through and exit from the switchable lenticular lenses 110. In particular, in a region or regions of the 2D/multiview switchable lenticular display 100 in which the switchable lenticular lenses 110 are in the ON state, light rays from the display panel 102 exit the switchable lenticular lenses 110 in directions corresponding to various view directions of a multiview image to provide multiview image content in theses region or regions.

According to some embodiments, the switchable lenticular lens array 108 may comprise a first material layer 112 having a fixed refractive index. The first material layer 112 may include fixed lenses of the switchable lenticular lens array 108. The switchable lenticular lens array 108 may include a second material layer 114 having an electrically controllable refractive index. For example, the second material 114 may comprise a birefringent liquid crystal having or exhibiting a first electrically controllable refractive index in a first controllable state and a second electrically controllable refractive index in a second controllable state. The first electrically controllable refractive index of the first controllable state may be configured to match or substantially match the fixed refractive index of the first material layer 112 and the second electrically controllable refractive index of the second controllable state may differ from the fixed refractive index of the first material layer 112, for example. In some embodiments, the second material layer 114 may contact the first material layer 112, such as along a boundary that is shaped with curved portions that may determine where the switchable lenticular lenses 110 are located in the switchable lenticular lens array 108. The second material layer 114 may fill in or substantially fill in shapes of the fixed lenses of the switchable lenticular lens array 108, e.g., as illustrated in FIG. 3. In some embodiments, the first material layer 112 may be disposed between the second material layer 114 and the display panel 102. In these embodiments, a fixed lens of the first material layer 112 may be a positive lens. In other embodiments, the second material layer 114 may be disposed between the first material layer 112 and the display panel 102. In these embodiments, a fixed lens of the first material layer 112 may be a negative lens. In the example of FIG. 3, the first material layer 112 is located between the array of light valves 106 and the second material layer 114, by way of example and not limitation.

In other embodiments (not illustrated), the second material layer 114 may be located between the array of light valves 106 and the first material layer 112. In the example of FIG. 3, a boundary between the first material layer 112 and the second material layer 114 is shaped to have a curved portion corresponding to each switchable lenticular lenses 110 in the switchable lenticular lens array 108. In the example of FIG. 3, the centers of the curved portions are a first distance away from the array of light valves 106, the edges of the curved portions are a second distance away from the array of light valves 106, and the second distance is less than the first distance. Alternatively, the second distance may be greater than the first distance. For all of these configurations, the curvature of the layer boundary and the refractive indices of the first material layer 112 and the second material layer 114 may be selected such that the switchable lenticular lenses 110 have a positive optical power.

In some embodiments, the switchable lenticular lens array 108 may comprise a one-dimensional (1D) array of cylindrical lenses that are arranged parallel to one another. The cylindrical lenses may be elongated in a vertical direction (such as along the X-direction in FIG. 3) and may direct light into a plurality of views 116 of the multiview image. The views 116 may be horizontally adjacent to one another (such as having adjacent locations along the Y-direction in FIG. 3). In some embodiments, the cylindrical lenses in the ON state may have a focal length selected such that at a specified viewing plane 118, the views 116 may have a center-to-center spacing 120 that corresponds to an average interpupillary distance of a human.

In other embodiments, the switchable lenticular lens array 108 may comprise a two-dimensional array of lenses. In some embodiments, a switchable lenticular lens 110 in the switchable lenticular lens array 108 may be a rotationally symmetric lens, such as a lens that is symmetric about a longitudinal axis of the lens. In some embodiments, a switchable lenticular lens 110 in the switchable lenticular lens array 108 may be a rotationally asymmetric lens, such as an anamorphic lens. An anamorphic lens may have a first focal length along a first direction (such as along the X-direction in FIG. 3) and a second focal length along a second direction (such as along the Y-direction in FIG. 3) that is orthogonal to the first direction.

In some configurations, the switchable lenticular lens array 108 may include electrodes 122 configured to deliver at least one of a voltage or a current to switch switchable lenticular lenses 110 of the switchable lenticular lens array 108 independently of the other switchable lenticular lenses 110 of the switchable lenticular lens array 108. For example, the electrodes 122 may be configured to switch every switchable lenticular lens 110 independently of every other switchable lenticular lens. The electrodes 122 may include a first electrode and a second electrode configured to apply a voltage or deliver a current across a region of the second material layer 114. The region may correspond to a single switchable lenticular lens 110 or a group of switchable lenticular lenses 110. In some embodiments, the first electrode or the second electrode may extend over some or all of the second material layer 114, while the second electrode or the first electrode may extend over an area that corresponds to a single switchable lenticular lens. According to various embodiments, the electrodes 122 may be transparent or substantially transparent, e.g., the electrodes 122 may comprise indium tin oxide or a similar optically transparent electrode material.

In some embodiments, the switchable lenticular lens array 108 may include electrodes 122 configured to switch the switchable lenticular lenses 110 in a region of the switchable lenticular lens array 108 corresponding to a zone of the composite image independent of switchable lenticular lenses 110 in regions of the switchable lenticular lens array 108 corresponding to other zones of the composite image. For embodiments, the electrodes 122 may be configured to switch a group of switchable lenticular lenses 110, together, independently of other switchable lenticular lenses 110 in the switchable lenticular lens array 108. The electrodes 122 may include a first electrode and a second electrode configured to apply a voltage or deliver a current across a region of the second material layer 114. The region may correspond to a group of switchable lenticular lenses 110. In some embodiments, one of the electrodes 122 may extend over some or all of the second material layer 114, while an opposing electrode 122 may extend over an area that corresponds to multiple switchable lenticular lenses 110, such as in a specified zone of the composite image.

In some embodiments (e.g., as illustrated in FIG. 3), the 2D/multiview switchable lenticular display 100 further comprises a lens controller 124. The lens controller 124 may be configured to control the electrically controllable refractive index of the second material layer 114 to have a refractive index that differs from the fixed refractive index to provide the ON state. The lens controller 124 may further control the electrically controllable refractive index of the second material layer 114 to have a refractive index that matches the fixed refractive index to provide the OFF state. For example, the lens controller 124 may selectively supply at least one of a voltage or a current to particular electrode pairs of the electrodes 122 which, in turn, are configured to distribute the at least one of the voltage or the current over suitable area(s) of the switchable lenticular lens array 108. For zonal switching, the lens controller 124 may switch the switchable lenticular lenses 110 of a zone of the composite image, together, between the ON state to provide the multiview image and the OFF state to provide the 2D image. In the example of FIG. 3, the lens controller 124 is part of the display panel 102. In other embodiments, the lens controller 124 may not be part of the display panel 102.

In some embodiments, the 2D/multiview switchable lenticular display 100 may further comprise a controller 130. In various embodiments, the controller 130 may be configured to provide a video image signal or a static image signal to the light valve array 106. The video image signal or a static image signal may include data that corresponds to a video image or a static image that may be displayed on the 2D/multiview switchable lenticular display 100. The controller 130 may be connected by a wireless or wired connection to receive the video image signal or the static image signal from a server or network. In some embodiments, the controller 130 may be configured to provide a separate video image signal or a separate static image signal for each view direction of the 2D/multiview switchable lenticular display 100. In some embodiments, the controller 130 may further control the lens controller 124 or the light source in the backlight 104. An optional eye tracker 126 may determine positions of eyes 128 of the user and may provide data representing the eye positions to the controller 130. In the example of FIG. 3, the controller 130 is not part of the display panel 102; in other configurations, the controller 130 may be part of the display panel 102.

According to various embodiments, the display panel 102 of the 2D/multiview switchable lenticular display 100 may be configured to provide the pixels of the composite image by either temporal mixing or zonal mixing of pixels representing the multiview image content and the 2D image content within the composite image.

Temporal mixing may comprise time-multiplexing the ON and OFF states of the switchable lenticular lenses 110 of the switchable lenticular lens array 108 to time-multiplex the multiview image content and the 2D image content within the composite image. For example, for a particular region of the composite image, the display panel 102 may alternate in time between displaying multiview image content (and setting the switchable lenticular lenses 110 to the ON state) and displaying 2D image content (and setting the switchable lenticular lenses 110 to the OFF state). The alternating in time may occur every video frame, or at another suitable time-multiplexing rate. For time-multiplexing rates that are higher than a response rate of a human eye, the temporal mixing may be perceived as a 2D image superimposed on a multiview image. As a viewer moves in the field of view of the display panel 102, the multiview image may change from view to view, while the 2D image remains invariant.

Zonal mixing may comprise switching different subsets of the switchable lenticular lenses 110 in different regions of the switchable lenticular array corresponding to different zones of the composite image to the ON state to provide the multiview image content and to the OFF state to provide the 2D image content. For example, a first region of the display panel 102 may be configured to provide the multiview image content, and a second region of the display panel 102 may be configured to provide the 2D image content. In some embodiments, the multiview image content and the 2D image content may be provided simultaneously. As a viewer moves in the field of view of the display panel 102, the multiview image may change from view to view in the first region, while the 2D image remains invariant in the second region.

In an example of zonal mixing, the pixels of the composite image may be grouped into mutually exclusive subsets of pixels. Each subset of pixels may correspond to a respective switchable lenticular lens 110 of the switchable lenticular lens array 108. A switchable lenticular lens 110 of the switchable lenticular lens array 108 is configured to direct light from the corresponding subset of pixels into respective view directions of the multiview image as a view pixel of the different views of the multiview image when the switchable lenticular lens 110 is in the ON state.

In the example of FIG. 3, the switchable lenticular lens array 108 includes three switchable lenticular lenses 110A, 110B, 110C. Each switchable lenticular lens 110A, 110B, 110C is associated with six light valves 106 of the array of light valves 106. The leftmost switchable lenticular lens 110A is associated with the leftmost group 132 of light valves. The rightmost switchable lenticular lens 110C is associated with the rightmost group 134 of light valves. The center switchable lenticular lens 110B is associated with the central group 136 of light valves. Each of the three groups of light valves corresponds to a respective zone of the composite image. FIG. 3 shows the leftmost switchable lenticular lens as being in the OFF state (as indicated by the dashed lines), and the center and rightmost switchable lenticular lenses as being in the ON state. As a result, the leftmost zone of the composite image appears in 2D, while the center and rightmost zones of the composite image appear in multiview.

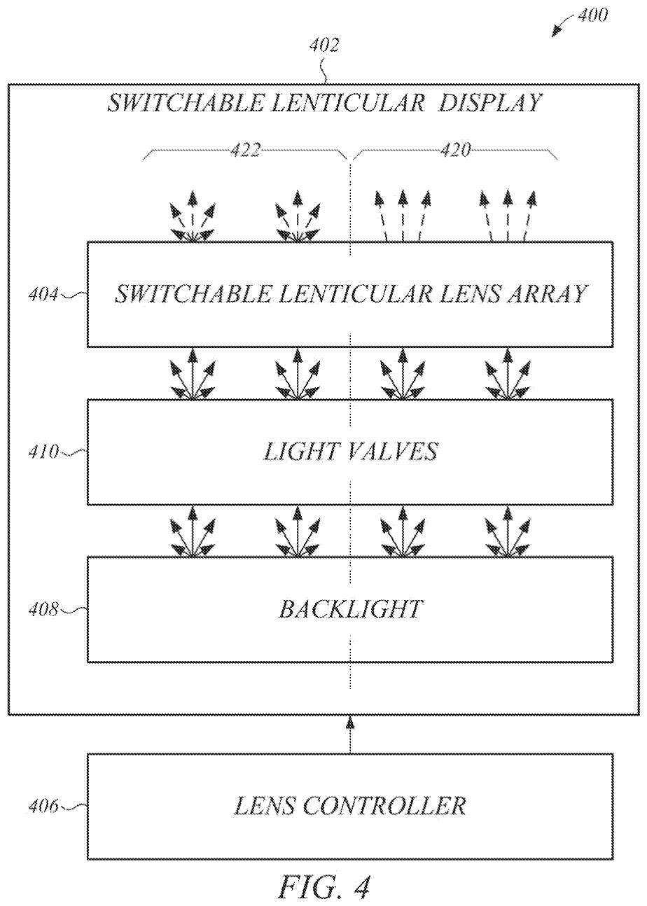

FIG. 4 illustrates a block diagram of a 2D/multiview switchable lenticular system 400 in an example, according to an embodiment of the principles described herein. As illustrated, the 2D/multiview switchable lenticular system 400 comprises a switchable lenticular display 402 configured to provide a composite image comprising both multiview image content and two-dimensional (2D) image content. The switchable lenticular display 402 may include a switchable lenticular lens array 404 having switchable lenticular lenses that are switchable between an ON state and an OFF state. In some embodiments, the switchable lenticular lens array 404 may be substantially similar to the switchable lenticular lens array 108, described above.

The 2D/multiview switchable lenticular system 400 illustrated in FIG. 4 further comprises a lens controller 406. The lens controller 406 is configured to provide the composite image using either temporal mixing or zonal mixing of the multiview image content and 2D image content. Temporal mixing may include time-multiplexing an ON state and an OFF state of the switchable lenticular lenses of the switchable lenticular lens array 404 to superimpose the multiview image content and 2D image content within the composite image. The time-multiplexing may include a duty cycle that may optionally be controlled or varied to control or vary relative intensities of the multiview image content and 2D image content within the composite image. Zonal mixing may include selectively switching ON switchable lenticular lenses in a first zone 420 of the composite image to provide the multiview image content in the first zone 420 and selectively switching OFF switchable lenticular lenses in a second zone 422 of the composite image to provide the 2D image content in the second zone 422. In some embodiments, the lens controller 406 may be substantially similar to the lens controller 124, described above.

In some embodiments, the switchable lenticular lens array 404 may include a first material layer having a fixed refractive index. The first material layer may include fixed lenses of the switchable lenticular lens array 404. In some embodiments, the first material layer of the switchable lenticular lens array 404 may be substantially similar to the first material layer 112, described above.

The switchable lenticular lens array 404 may include a second material layer having an electrically controllable refractive index. The second material layer of the switchable lenticular lens array 404 may be in contact with the first material layer and may fill in or substantially fill in shapes of the fixed lenses of the switchable lenticular lens array 404. The electrically controllable refractive index may have a first controllable state that matches the fixed refractive index of the first material layer and a second controllable state that differs from the fixed refractive index. In some embodiments, the second material layer of the switchable lenticular lens array 404 may be substantially similar to the second material layer 114, described above.

In some embodiments, the switchable lenticular lens array 404 may include electrodes configured to selectively deliver a current or a voltage to switch switchable lenticular lenses of the switchable lenticular lens array 404 independently of the other switchable lenticular lenses of the switchable lenticular lens array. In some embodiments, the electrodes may be substantially similar to the electrodes 122, described above.

In some embodiments, the switchable lenticular lens array 404 may include electrodes configured to selectively deliver a current or voltage to switch the switchable lenticular lenses in a region of the switchable lenticular lens array 404 corresponding to a zone of the composite image independently of switchable lenticular lenses in regions of the switchable lenticular lens array 404 corresponding to other zones of the composite image. In some embodiments, the electrodes of the switchable lenticular lens array 404 may be substantially similar to the electrodes 122, described above.

In some embodiments, a switchable lenticular lens in the switchable lenticular lens array 404 may be a cylindrical lens. The cylindrical lens may be elongated in a vertical direction and is configured to direct light in directions corresponding to a plurality of views of the multiview image. The views may be horizontally adjacent to one another. In some embodiments, the cylindrical lens in the ON state may have a focal length selected such that at a specified viewing plane, the views may have a center-to-center spacing that corresponds to an average interpupillary distance of a human. In some embodiments (e.g., as illustrate in FIG. 4), the 2D/multiview switchable lenticular system 400 may optionally comprise a backlight 408 that is substantially similar to the backlight 104, described above. In some embodiments (e.g., as illustrated in FIG. 4), the 2D/multiview switchable lenticular system 400 may optionally include an array of light valves 410 that is be substantially similar to the array of light valves 106, described above.

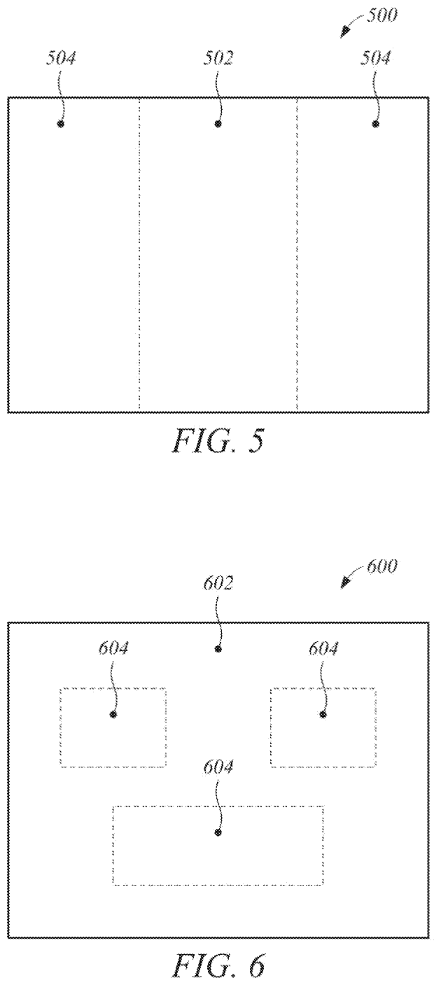

FIG. 5 illustrates a plan view a composite image 500 in an example, according to an embodiment of the principles described herein. The illustrated composite image 500 may represent the composite image provided by one or both of the 2D/multiview switchable lenticular display 100 of FIG. 3 and the 2D/multiview switchable lenticular system 400 of FIG. 4, for example. The multiview image content 502 or the 2D image content 504 may optionally include regions that are non-contiguous. In the example of FIG. 5, the composite image 500 includes a central region of multiview image content 502 surrounded on opposite sides by regions of 2D image content 504. In some embodiments, such as the example of FIG. 5, one or more boundaries between the multiview image content 502 and the 2D image content 504 may be parallel to an edge of the composite image 500. In some embodiments, such as the example of FIG. 5, one or more boundaries between the multiview image content 502 and the 2D image content 504 may extend along a full extent of the composite image 500.

FIG. 6 illustrates a plan view of a composite image 600 in another example, according to an embodiment of the principles described herein. The illustrated composite image 600 may represent the composite image provided by one or both of the 2D/multiview switchable lenticular display 100 of FIG. 3 and the 2D/multiview switchable lenticular system 400 of FIG. 4, for example. The multiview image content 602 or the 2D image content 604 may optionally include regions that are non-contiguous. In the example of FIG. 6, the composite image 600 includes a region of multiview image content 602 that surrounds at least one region of 2D image content 604. In another example (not illustrated), the 2D content region may surround one or more regions of multiview content. It should be understood that the examples of FIGS. 5 and 6 are but specific examples of how multiview image content and 2D image content may be located within a composite image and are not meant to limiting as to the configuration and placement of the multiview content and 2D image content regions.

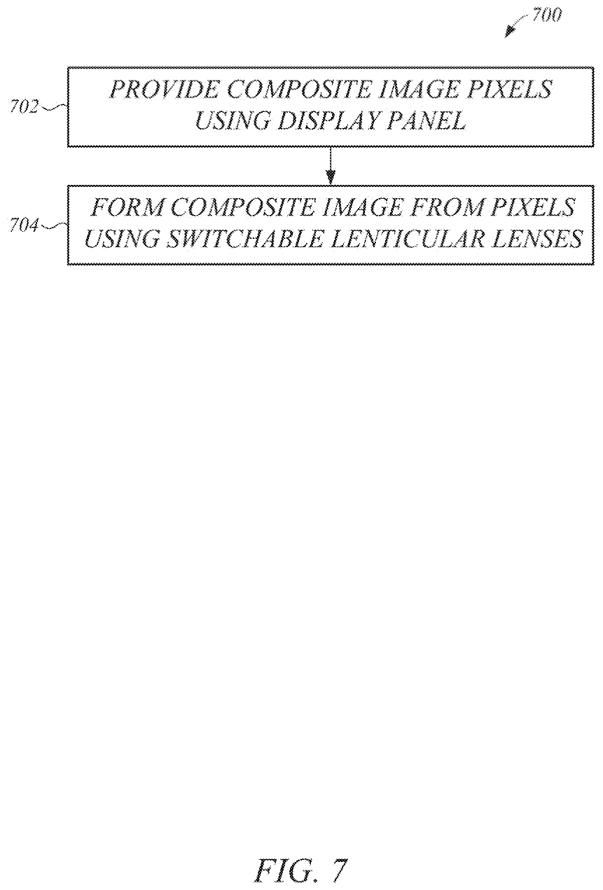

FIG. 7 illustrates a flow chart of a method 700 of operating a 2D/multiview switchable lenticular display in an example, according to an embodiment of the principles described herein. The method 700 may be executed by the 2D/multiview switchable lenticular display 100, the 2D/multiview switchable lenticular system 400, or by another suitable system. The method 700 is but one example of a method of operating a 2D/multiview switchable lenticular display. Other suitable methods may also be used. As illustrated in FIG. 7, the method 700 of operating a 2D/multiview switchable lenticular display comprises providing 702 pixels of a composite image using a display panel. According to various embodiments, the composite image comprises both multiview image content and two-dimensional (2D) image content. In some embodiments, the display panel may be substantially similar to the display panel 102 described above with respect to the 2D/multiview switchable lenticular display 100.

The method 700 of operating a 2D/multiview switchable lenticular display further comprises using 704 a switchable lenticular lens array to form the composite image from the pixels. According to various embodiments, switchable lenticular lenses of the switchable lenticular lens array are switchable between an ON state to provide the multiview image content from corresponding pixels of the composite image and an OFF state to provide the 2D image content from corresponding pixels of the composite image. The composite image may be provided either by temporal mixing or zonal mixing of pixels representing the multiview image content and the 2D image content within the composite image, in various embodiments.

In some embodiments, temporal mixing may comprise time-multiplexing the ON and OFF states of the switchable lenticular lenses of the switchable lenticular lens array to time-multiplex the multiview image content and 2D image content within the composite image. In some embodiments, zonal mixing may comprise switching different subsets of the switchable lenticular lenses in different regions of the switchable lenticular array corresponding to different zones of the composite image to the ON state to provide the multiview image content and to the OFF state to provide the 2D image content.

In some embodiments, the switchable lenticular lens array may be substantially similar to the above-described switchable lenticular lens array 108 of the 2D/multiview switchable lenticular display 100. In particular, in some embodiments, the switchable lenticular lens array may include a first material layer having a fixed refractive index. The first material layer may include fixed lenses of the switchable lenticular lens array. In some embodiments, the switchable lenticular lens array may include a second material layer having an electrically controllable refractive index. The second material layer may contact the first material layer and may fill in shapes of the fixed lenses of the switchable lenticular lens array.

In some embodiments, switching a switchable lenticular lens of the switchable lenticular lens array to the ON state may comprise controlling the electrically controllable refractive index of the second material layer to have a refractive index that differs from the fixed refractive index. In some embodiments, switching a switchable lenticular lens of the switchable lenticular lens array to the OFF state may include controlling the electrically controllable refractive index of the second material layer to have a refractive index that matches the fixed refractive index.

In some embodiments, the switchable lenticular lens array may include a one-dimensional array of cylindrical lenses that are arranged parallel to one another. The cylindrical lenses may be elongated in a vertical direction. The cylindrical lenses may direct light into a plurality of views of the multiview image. The views may be horizontally adjacent to one another. In some embodiments, the cylindrical lens in the ON state may have a focal length selected such that at a specified viewing plane, the views have a center-to-center spacing that corresponds to an average interpupillary distance of a human. In some embodiments, the switchable lenticular lens array may include a two-dimensional array of lenses. In some embodiments, a switchable lenticular lens in the switchable lenticular lens array may be a rotationally symmetric lens.

Thus, there have been described examples and embodiments of a multiview display that includes virtual light sources of a finite size illuminating a light valve array. It should be understood that the above-described examples are merely illustrative of some of the many specific examples that represent the principles described herein. Clearly, those skilled in the art may readily devise numerous other arrangements without departing from the scope as defined by the following claims.

1-29. (canceled)

30. A 2D/multiview switchable lenticular display comprising:
a display panel configured to provide pixels of a composite image comprising both multiview image content and two-dimensional (2D) image content; and
a switchable lenticular lens array configured to form the composite image from the pixels, the switchable lenticular lens array having switchable lenticular lenses that are switchable between an ON state to provide the multiview image content from corresponding pixels of the composite image and an OFF state to provide the 2D image content from corresponding pixels of the composite image,
the composite image being provided using the switchable ON and OFF states by either temporal mixing or zonal mixing of pixels representing the multiview image content and the 2D image content within the composite image.

31. The 2D/multiview switchable lenticular display of claim 30, wherein:
the temporal mixing comprises time-multiplexing the ON state and the OFF state of the switchable lenticular lenses of the switchable lenticular lens array to time-multiplex the multiview image content and the 2D image content within the composite image; and
the zonal mixing comprises switching different subsets of the switchable lenticular lenses in different regions of the switchable lenticular array corresponding to different zones of the composite image to the ON state to provide the multiview image content and to the OFF state to provide the 2D image content.

32. The 2D/multiview switchable lenticular display of claim 30, wherein in the zonal mixing:
the pixels of the composite image are grouped into mutually exclusive subsets of pixels;
each subset of pixels corresponds to a respective switchable lenticular lens of the switchable lenticular lens array; and
a switchable lenticular lens of the switchable lenticular lens array is configured to direct light from the corresponding subset of pixels into respective view directions of the multiview image as a view pixel of different views of the multiview image when the switchable lenticular lens is in the ON state.

33. The 2D/multiview switchable lenticular display of claim 30, wherein the display panel includes a backlight configured to emit light and an array of light valves configured to modulate the light emitted by the backlight to provide the pixels.

34. The 2D/multiview switchable lenticular display of claim 30, wherein the switchable lenticular lens array comprises:
a first material layer having a fixed refractive index and comprising fixed lenses of the switchable lenticular lens array; and
a second material layer having an electrically controllable refractive index, the second material layer contacting the first material layer and filling in shapes of the fixed lenses of the switchable lenticular lens array, the electrically controllable refractive index having a first controllable state that matches the fixed refractive index and a second controllable state that differs from the fixed refractive index.

35. The 2D/multiview switchable lenticular display of claim 34, wherein:
the first material layer is disposed between the second material layer and the display panel; and
a fixed lens of the first material layer is a positive lens.

36. The 2D/multiview switchable lenticular display of claim 34, wherein:
the second material layer is disposed between the first material layer and the display panel; and
a fixed lens of the first material layer is a negative lens.

37. The 2D/multiview switchable lenticular display of claim 34, wherein the switchable lenticular lens array includes electrodes configured to deliver at least one of a voltage or a current to switch switchable lenticular lenses of the switchable lenticular lens array independently of other switchable lenticular lenses of the switchable lenticular lens array.

38. The 2D/multiview switchable lenticular display of claim 34, wherein the switchable lenticular lens array includes electrodes configured to deliver at least one of a voltage or a current to switch the switchable lenticular lenses in a region of the switchable lenticular lens array corresponding to a zone of the composite image independent of switchable lenticular lenses in regions of the switchable lenticular lens array corresponding to other zones of the composite image.

39. The 2D/multiview switchable lenticular display of claim 34, further comprising a lens controller configured to:
control the electrically controllable refractive index of the second material layer to have a refractive index that differs from the fixed refractive index to provide the ON state; and
control the electrically controllable refractive index of the second material layer to have a refractive index that matches the fixed refractive index to provide the OFF state,
wherein for zonal switching, the lens controller is configured to switch the switchable lenses of a zone of the composite image, together, between the ON state to provide the multiview image and the OFF state to provide the 2D image.

40. The 2D/multiview switchable lenticular display of claim 30, wherein:
the switchable lenticular lens array comprises a one-dimensional array of cylindrical lenses that are arranged parallel to one another;
the cylindrical lenses are elongated in a vertical direction and are configured to direct light into a plurality of views of the multiview image;
the views are horizontally adjacent to one another; and
the cylindrical lens in the ON state has a focal length selected such that at a specified viewing plane, the views have a center-to-center spacing that corresponds to an average interpupillary distance of a human.

41. The 2D/multiview switchable lenticular display of claim 30, wherein:
the switchable lenticular lens array comprises a two-dimensional array of lenses; and
a switchable lenticular lens in the switchable lenticular lens array is a rotationally symmetric lens.

42. A method of operating a 2D/multiview switchable lenticular display, the method comprising:
providing pixels of a composite image using a display panel, the composite image comprising both multiview image content and two-dimensional (2D) image content; and
using a switchable lenticular lens array to form the composite image from the pixels, switchable lenticular lenses of the switchable lenticular lens array being switchable between an ON state to provide the multiview image content from corresponding pixels of the composite image and an OFF state to provide the 2D image content from corresponding pixels of the composite image,
wherein the composite image is provided by either temporal mixing or zonal mixing of pixels representing the multiview image content and the 2D image content within the composite image.

43. The method of operating a 2D/multiview switchable lenticular display of claim 42, wherein:
temporal mixing comprises time-multiplexing the ON state and the OFF state of the switchable lenticular lenses of the switchable lenticular lens array to time-multiplex the multiview image content and 2D image content within the composite image; and
zonal mixing comprises switching different subsets of the switchable lenticular lenses in different regions of the switchable lenticular array corresponding to different zones of the composite image to the ON state to provide the multiview image content and to the OFF state to provide the 2D image content.

44. The method of operating a 2D/multiview switchable lenticular display of claim 42, wherein:
the switchable lenticular lens array comprises:
a first material layer having a fixed refractive index and comprising fixed lenses of the switchable lenticular lens array; and
a second material layer having an electrically controllable refractive index, the second material layer contacting the first material layer and filling in shapes of the fixed lenses of the switchable lenticular lens array;
switching a switchable lenticular lens of the switchable lenticular lens array to the ON state comprises controlling the electrically controllable refractive index of the second material layer to have a refractive index that differs from the fixed refractive index; and
switching a switchable lenticular lens of the switchable lenticular lens array to the OFF state comprises controlling the electrically controllable refractive index of the second material layer to have a refractive index that matches the fixed refractive index.

45. A 2D/multiview switchable lenticular system comprising:
a switchable lenticular display configured to provide a composite image comprising both multiview image content and two-dimensional (2D) image content,
the switchable lenticular display including a switchable lenticular lens array having switchable lenticular lenses that are switchable between an ON state and an OFF state; and
a lens controller configured to provide the composite image using either temporal mixing or zonal mixing of the multiview image content and 2D image content,
wherein temporal mixing comprises time-multiplexing the ON state and the OFF state of the switchable lenticular lenses to superimpose the multiview image content and 2D image content within the composite image, and
wherein zonal mixing comprises selectively switching ON switchable lenticular lenses in a first zone of the composite image to provide the multiview image content in the first zone and selectively switching OFF switchable lenticular lenses in a second zone of the composite image to provide the 2D image content in the second zone.

46. The 2D/multiview switchable lenticular system of claim 45, wherein the switchable lenticular lens array comprises:
a first material layer having a fixed refractive index and comprising fixed lenses of the switchable lenticular lens array; and
a second material layer having an electrically controllable refractive index, the second material layer contacting the first material layer and filling in shapes of the fixed lenses of the switchable lenticular lens array, the electrically controllable refractive index having a first controllable state that matches the fixed refractive index and a second controllable state that differs from the fixed refractive index.

47. The 2D/multiview switchable lenticular system of claim 46, wherein the switchable lenticular lens array includes electrodes configured to deliver at least one of a voltage or a current to switch switchable lenticular lenses of the switchable lenticular lens array independent of the other switchable lenticular lenses of the switchable lenticular lens array.

48. The 2D/multiview switchable lenticular system of claim 46, wherein the switchable lenticular lens array includes electrodes configured to deliver at least one of a voltage to switch the switchable lenticular lenses in a region of the switchable lenticular lens array corresponding to a zone of the composite image independent of switchable lenticular lenses in regions of the switchable lenticular lens array corresponding to other zones of the composite image.

49. The 2D/multiview switchable lenticular system of claim 46, wherein:
a switchable lenticular lens in the switchable lenticular lens array is a cylindrical lens, the cylindrical lens being elongated in a vertical direction and configured to direct light in directions corresponding to a plurality of views of the multiview image, the views being horizontally adjacent to one another,
wherein the cylindrical lens in the ON state has a focal length selected such that at a specified viewing plane, the views have a center-to-center spacing that corresponds to an average interpupillary distance of a human.
